(19) United States
(12) Patent Application Publication
(10) Pub. No.: US 2026/0254432 A1
(43) Pub. Date: Aug. 27, 2026

(54) TUNABLE IMPEDANCE MATCHING METHODS AND CIRCUITS FOR PROTECTION AGAINST SIDE-CHANNEL ATTACKS

(71) Applicant: Applied Materials, Inc., Santa Clara, CA (US)

(72) Inventors: Md Sadik AWAL, Miami, FL (US); Mudit Sunilkumar KHASGIWALA, Los Gatos, CA (US)

(73) Assignee: Applied Materials, Inc., Santa Clara, CA (US)

(21) Appl. No.: 19/061,738

(22) Filed: Feb. 24, 2025

(51) Int. Cl. H03H 7/40; G01R 27/32; H03M 1/12

(52) U.S. Cl. CPC H03H 7/40; G01R 27/32; H03M 1/12

(57) ABSTRACT

Board-level transmissions can inadvertently reveal secret information when intercepted by an EM probe within range of an electronic assembly. To mitigate the side-channel attacks, an electronic assembly may measure a real-time impedance at a receiving subsystem to detect changes in the impedance caused by the added impedance of the EM probe. A controller may then look up electric and magnetic field values corresponding to the measured impedance to identify a location of the EM probe. Component values may be selected for an adjustable impedance to steer the EM emissions away from the EM probe. The system may react continuously to any movements of the probe to adjust the direction of any EM emissions away from the probe.

### TECHNICAL FIELD

This disclosure generally relates to methods and circuits for detecting, preventing, and/or thwarting side-channel attacks in electronic systems. More specifically, this disclosure describes a tunable impedance circuit and detection system for detecting a side-channel attack and adjusting the system characteristics to steer electromagnetic radiation away from a nearby probe location.

### BACKGROUND

A side-channel in a digital system refers to an unintended communication pathway that leaks information about the internal operations or state of the system. Unlike primary communication channels, which are intentionally designed and documented, side-channels emerge from secondary, often physical, characteristics of the system. These characteristics may include electromagnetic radiation, power consumption, acoustic signals, or timing information. Side-channels are particularly relevant in the context of system security, as they can be exploited to infer sensitive data, such as cryptographic keys or user credentials. For example, fluctuations in power consumption during cryptographic operations can reveal patterns that allow an attacker to deduce private keys. Similarly, differences in execution time for certain computations can expose vulnerabilities to timing attacks.

### BRIEF SUMMARY

In some embodiments, an electronic assembly may include a first subsystem and a second subsystem, where signals may be transmitted between the first subsystem and the second subsystem. The electronic assembly may also include a tuning circuit with an adjustable impedance through which the signals are transmitted, and a sensor configured to measure an impedance characteristic associated with the signals as the signals are transmitted between the first subsystem and the second subsystem. The electronic assembly may also include a controller programmed to determine, based on the impedance characteristic, that an electromagnetic (EM) probe is within range of the electronic assembly; and to change the adjustable impedance of the tuning circuit to direct EM emissions from the signals away from the EM probe.

In some embodiments, a method of mitigating a side-channel attack may include transmitting signals between a first subsystem and a second subsystem of an electronic assembly; measuring an impedance characteristic associated with the signals as the signals are transmitted between the first subsystem and the second subsystem; determining, based on the impedance characteristic, that an EM probe is within range of the electronic assembly; and directing EM emissions from the signals away from the EM probe.

In some embodiments, one or more non-transitory computer-readable media may include instructions that, when executed by one or more processors, cause the one or more processors to perform operations including receiving an impedance characteristic associated with signals that are transmitted between a first subsystem and a second subsystem on an electronic assembly; determining, based on the impedance characteristic, that an EM probe is within range of the electronic assembly; and determining component values for a tuning circuit with an adjustable impedance through which the signals are transmitted. The component values may be configured to cause EM emissions from the signals to be directed away from the EM probe.

In any embodiments, any and all of the following features may be implemented in any combination and without limitation. The tuning circuit may include one or more adjustable capacitors and one or more inductors. The tuning circuit may be configured to operate as a matching circuit to adjust the adjustable impedance such that the tuning circuit approximates a direct current (DC) short-circuit and a radio frequency (RF) open circuit when the EM probe is not within range of the electronic assembly. The sensor configured to measure the impedance may include an S11 coupler between the tuning circuit and the second subsystem. An analog-to-digital converter (ADC) may be configured to receive an analog output of the sensor and to provide a digital input to the controller. The first subsystem may include a switch-mode power supply (SMPS). The controller may include a plurality of controllers, processors, systems-on-a-chip, or digital systems. A data structure may be populated with EM characteristics of the electronic assembly at a plurality of different operating frequencies of the first subsystem, where the EM characteristics may include an impedance with electric field components and magnetic field components. The data structure may be populated with the EM characteristics for a plurality of harmonic frequenat each of the different operating frequencies of the first subsystem. Populating a data structure with the EM characteristics may include simulating the first subsystem at each of the different operating frequencies with a plurality of different impedance measurements, where the simulation may provide the electric field components and the magnetic field components at each of the plurality of different impedance measurements. Directing the EM emissions from the signals away from the EM probe may include determining component values for a tuning circuit with an adjustable impedance through which the signals are transmitted, where the component values may cause the EM emissions from the signals to have less than a threshold signal-to-noise ratio (SNR) in a direction of the EM probe. Noise may be injected into the signals being transmitted between the first subsystem and the second subsystem. The method/operations may also include measuring the impedance characteristic associated with the signals after directing the EM emissions from the signals away from the EM probe; determining, based on the impedance characteristic, that the EM probe has moved to a new location; and redirecting the EM emissions from the signals away from the EM probe at the new location. Determining that the EM probe is within the range of the electronic assembly may include detecting a change in the impedance characteristic. A data structure storing impedance values for an operating frequency of the first subsystem may be accessed, where the data structure may include electric field components and magnetic field components for each impedance value. An electric field component and a magnetic field component may be determined or identified from the data structure based on the impedance characteristic. A position of the EM probe relative to the electronic assembly may be determined or calculated based on the electric field component and the magnetic field component. The component values may be determined for the tuning circuit corresponding to a second impedance with a second electric field component and a second magnetic field component that are directed away from the position of the EM probe.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates an electronic assembly that may be subject to a side-channel attack, according to some embodiments.

FIG. 2 illustrates a flowchart of a method for detecting and mitigating side-channel attacks, according to some embodiments.

FIG. 3 illustrates a partial schematic of the electronic assembly, according to some embodiments.

FIG. 4 illustrates an example of the data structure storing various EM characteristics of the system, according to some embodiments.

FIG. 5A illustrates an EM probe is within range of the electronic assembly, according to some embodiments.

FIG. 5B illustrates the EM emissions being directed away from the EM probe, according to some embodiments.

FIG. 6 illustrates an exemplary controller, in which various embodiments may be implemented.

### DETAILED DESCRIPTION

Board-level transmissions can inadvertently reveal secret information when intercepted by an electromagnetic (EM) probe within range of an electronic assembly. This type of “side-channel” attack can extract encoded information, operating parameters, power characteristics, and other confidential information. To mitigate the side-channel attacks, an electronic assembly may measure a real-time impedance at a receiving subsystem to detect changes in the impedance of the circuit (e.g., metal traces) caused by the added impedance of the nearby EM probe. A controller may then look up electric and magnetic field values corresponding to the measured impedance to identify a distance and orientation of the EM probe. Capacitance and/or inductance values may be selected in real time for a tuning circuit with an adjustable impedance to steer the EM emissions of the transmission away from the EM probe. The system may react immediately and continuously to any movements of the probe to adjust the direction of any EM emissions away from the probe. This reduces the need to inject noise or stop transmitting to avoid divulging secret information.

In the rapidly evolving landscape of modern electronics, the protection of sensitive information from side channel analysis has become a critical concern. Among the various physical side-channel attacks, electromagnetic (EM) side channel analysis has emerged as a particularly alarming threat. This is due to its non-invasive nature and effectiveness in extracting confidential information, including cryptographic keys, hardware design, and even parameters of large language models and deep neural networks.

A side-channel in a digital system refers to an unintended communication pathway that leaks information about the internal operations or state of the system. Unlike primary communication channels, which are intentionally designed and documented, side-channels emerge from secondary, often physical, characteristics of the system. These characteristics may include electromagnetic radiation, power consumption, acoustic signals, or timing information. Side-channels are particularly relevant in the context of system security, as they can be exploited to infer sensitive data, such as cryptographic keys or user credentials. For example, fluctuations in power consumption during cryptographic operations can reveal patterns that allow an attacker to deduce private keys. Similarly, differences in execution time for certain computations can expose vulnerabilities to timing attacks.

The primary vulnerability lies in conductive-level emissions, specifically resonance and radiation emissions. Attackers exploit unintentional electromagnetic (EM) emissions from chips, traces, and other exposed conductors, with higher-level metal layers being particularly susceptible. These top metal layers, being thicker, may exhibit lower resonance frequencies, making their EM leakage more easily detectable by commercially available low-cost EM probes. This presents a significant security risk, as the intensity of EM fields is directly influenced by the dimensions of these metal layers.

The field of side-channel analysis in hardware security has evolved significantly in recent years to move beyond traditional cryptanalysis approaches. While classical cryptography relies on computationally secure algorithms and protocols, the physical implementation of these algorithms in hardware can inadvertently leak sensitive information through various side channels, including power consumption and EM radiation. Current countermeasures to prevent EM side-channel leakages can be broadly classified into three main categories: logical countermeasures, architectural countermeasures, and physical (circuit-level) countermeasures.

Logical countermeasures include wave dynamic differential logic, dual-rail pre-charge circuits, sense amplifier-based logic, and gate-level masking. Although measures may be effective in some scenarios, they often come with trade-offs. Wave dynamic differential logic, though compatible with single-rail standard cell libraries, incurs high overheads in terms of chip area, power consumption, and performance degradation. Dual-rail pre-charge circuits equalize leakage signals but require custom gate designs. Sense amplifier-based logic ensures constant leakage across all transitions but usually necessitates a redesign of the cell library.

Architectural countermeasures distort the EM trace through amplitude or time obfuscation. Time distortion is often achieved by inserting dummy operations randomly or shuffling the order of operations. However, this approach provides limited protection due to the constrained number of operations that can be shuffled. The response is also based on the specific algorithm and architecture.

Physical (circuit-level) countermeasures include noise injection, isolation of critical circuits, filters, and shielding methods. While effective to some degree, these solutions often provide static protection limited to specific frequency bands. These physical countermeasures do not account for system frequency shifts caused by factors such as integrated voltage regulators.

In summary, all existing countermeasures share the common goal of reducing the signal-to-noise ratio (SNR) through two fundamental methods: noise injection and/or sensitive correlation signature suppression. These countermeasures obfuscate sensitive information by injecting noise and suppressing leakage signatures.

The embodiments described herein introduce new circuits and methodologies for preventing, detecting, and/or responding to EM side-channel attacks through the development of a tunable impedance matching circuit. These embodiments address the limitations of existing countermeasures by providing dynamic, adaptive protection against detection of EM leakage. To achieve the robust protection against EM side-channel attack, these embodiments operate in multiple phases. First, any leakage frequencies that could lead to resonance or radiation are actively identified and analyzed, and a dynamic noise map may be generated to guide the impedance circuit tuning. The proactive approach allows for immediate response to potential vulnerabilities. Next, a tunable impedance matching circuit capable of responding in real-time to detected leakage frequencies is implemented utilizing load-pull principles. This dynamic adjustment may ensure that protection remains effective even as system conditions change. In addition to varying the impedance of the circuit, other responses may be utilized, such as introducing additional signals at leakage frequencies to effectively camouflage sensitive information. This dual approach provides a more robust defense against sophisticated attach methods. However, the main response may alter the circuit's radiation pattern in response to nearby EM probes. This feature allows the circuit to dynamically modify its EM emissions in opposition to the probe, thereby rendering the probe ineffective in measuring the radiation pattern.

The proposed methods and systems offer multiple advantages over existing solutions. For example, the protection against side channel EM attacks is dynamic. Unlike static shielding or filtering methods, the embodiments described herein adapt to changing system conditions and attack vectors in real-time. For example, the system can respond to movements of the attack probe in real time. By focusing on impedance matching and targeted noise injection, these embodiments also minimize the performance overhead often associated with the traditional logical and architectural countermeasures described above. Additionally, these embodiments are agnostic to the type of physical circuit or logical transmission and can thus accommodate a wide range of different systems, circuit layouts, information types, cryptographic algorithms, and/or other circuit characteristics. The combination of impedance matching and active EM steering also provides a more sophisticated method of obscuring sensitive information compared to traditional techniques.

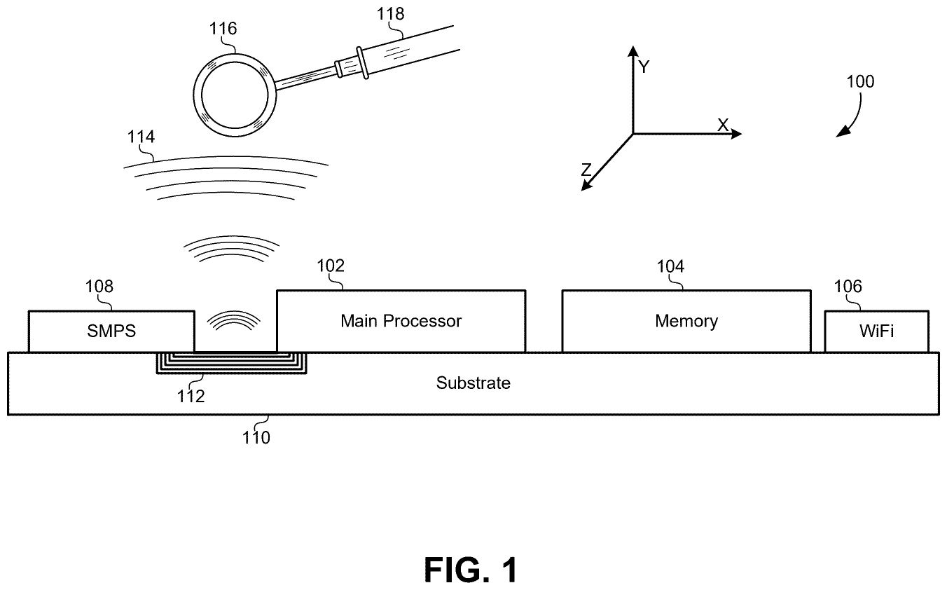

FIG. 1 illustrates an electronic assembly 100 that may be subject to a side-channel attack, according to some embodiments. Generally, the electronic assembly 100 may include a substrate 110 on which a plurality of subsystems may be mounted. The substrate 110 may include any type of substrate. For example, the substrate 110 may be made from a silicon substrate, a glass substrate, a gallium arsenide substrate, a silicon carbide substrate, a quartz or glass-ceramic substrate, and/or any other type of material. The substrate 110 may include any type of platform for electrically connecting, supporting, and/or integrating electronic components. The substrate 110 may include a silicon die or wafer, an interposer, a printed circuit board, or other similar components.

The electronic assembly 100 may include a plurality of subsystems. The subsystems may include smaller electronic assemblies made up of a plurality of silicon dies packaged together. The subsystems may also include individual silicon dies that are mounted directly to the substrate 110. By way of example, the electronic assembly 100 includes different types of silicon dies that may be mounted to the substrate, such as a main processor 102, a memory 104, a Wi-Fi chip 106, and so forth. Other subsystems may include collections of discrete board-level components that perform a specific function. For example, a switch-mode power supply (SMPS) 108 may include a silicon integrated circuit (IC) combined with discrete board level components, such as decoupling capacitors, resistors, inductors, and/or other components. Some embodiments may include cryptographic processors or other components configured to encrypt data and transmit encrypted data to the main processor 102.

The electronic assembly 100 may include a number of different locations where EM emissions may be available to a nearby EM probe 118 that is part of a side-channel attack. For example, the substrate 110 may include internal and/or external traces 112 that are on or near the surface of the substrate 110. Signals transmitted between the plurality of subsystems mounted to the substrate 110 through the external traces 112 may emit EM emissions as signals on those external traces 112 are propagated. Although only one set of external traces 112 are illustrated in FIG. 1, many different types of traces or communication pathways may be susceptible to side-channel attacks. For example, exposed pins, connectors, traces, wiring, unintentional antennas, and other conductive components may provide vulnerabilities for side-channel attacks. More generally, any conductive pathway transmitting logic signals may be susceptible to side-channel attacks. For example, connections between processors and cryptographic accelerators, memories, graphic processing units, communication hardware, cryptographic hardware, connectors, communication interfaces, and so forth may transmit logical information (e.g., encrypted or unencrypted data) that may be susceptible to side-channel attacks. Additionally, signal and clock generators, oscillators, power regulators, sensors, power management units, and other power or operational subsystems may also provide information that may be useful in a side channel attack. For example, determining when and how power is cycled, clocks are pulsed, and/or systems are active may provide sensitive information regarding the electronic assembly 100.

More generally, connections between any of the components above may be subject to a side-channel attack. For example, any two subsystems may have signals transmitted between those two subsystems to generate EM emissions that may be detectable by EM probe within range of the electronic assembly. Although FIG. 1 illustrates a specific example of an SMPS 108 providing DC power signals to a main processor 102, these subsystems with the associated external traces 112 are provided only by way of example and are not meant to be limiting. Therefore, this disclosure may refer generically to any two subsystems that are subject to a side-channel attack as a “first subsystem” and a “second” subsystem. The terms “first” and “second” are only used to distinguish one subsystem from another. These terms are not meant to imply order, preference, importance, or any other distinguishing characteristic. For example, in some embodiments, the first subsystem may be a transmitting or source system, and the second subsystem may be a receiving subsystem. However, other embodiments may include bidirectional signaling between the first and second subsystems without a specific sender or receiver.

Many different types of devices may be used to perpetrate a side channel attack. For example, an EM probe 118 engaging in a side-channel attack may include a sensor or antenna component 116 that may be placed within a predetermined range of the electronic assembly 100. For example, the EM probe 118 may be considered to be “in range” of the electronic assembly 100 when the EM probe is able to read or intercept EM emissions 114 that are emitted by the electronic assembly 100. Alternatively, the EM probe 118 may be considered to be “in range” of the electronic assembly 100 when an impedance of the EM probe 118 detectably changes a measured impedance of the transmission path of signals transmitted in the electronic assembly 100. For example, the sensor or antenna component 116 of the EM probe 118 may contribute a significant impedance to a circuit or communication pathway on the electronic assembly 100. When this impedance is detectable, the EM probe 118 may be considered to be in range and detectable by the electronic assembly 100.

The EM probe 118 may also have a location that is detectable relative to the electronic assembly 100. The location may include a distance from the electronic assembly 100 and an orientation or angle relative to the electronic assembly 100. For example, as depicted in FIG. 1, the substrate 110 of the electronic assembly 100 may be oriented in an XZ plane. The EM probe 118 may be located in the XY plane perpendicular to the XZ plane. As the EM probe 118 moves relative to this position, changes in the distance from the electronic assembly 100 and the orientation or angle relative to the electronic assembly 100 may be detected using this frame of reference.

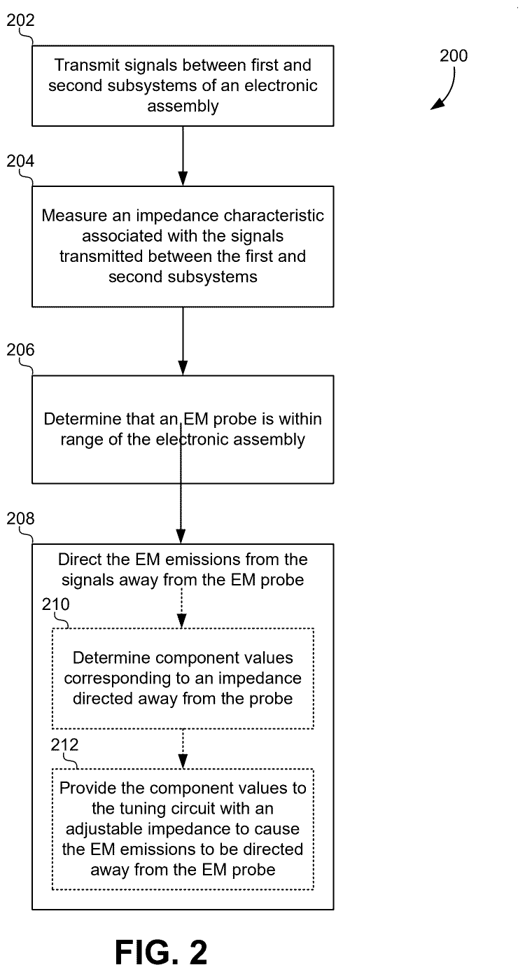

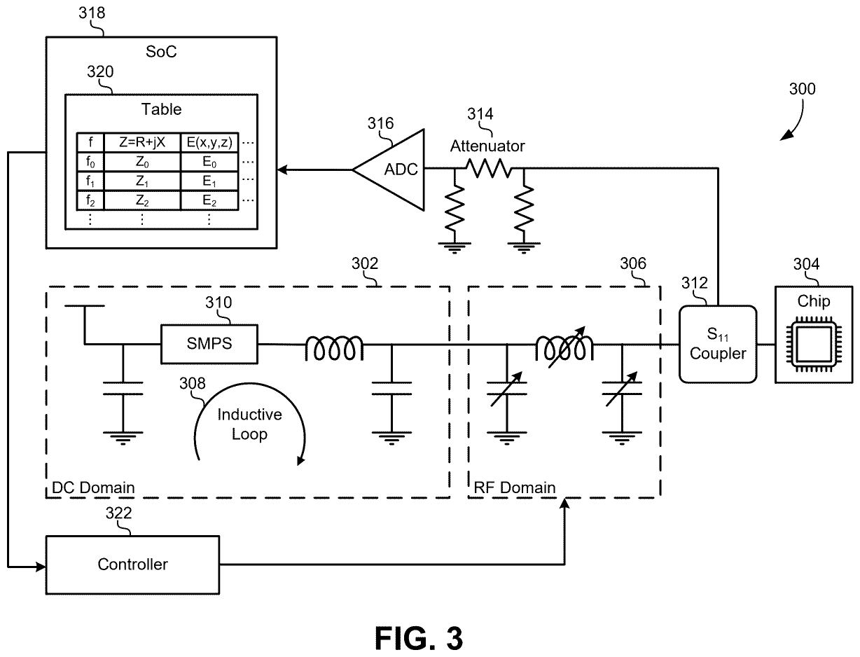

FIG. 2 illustrates a flowchart of a method 200 for detecting and mitigating side-channel attacks, according to some embodiments. This method 200 may be executed by any combination of systems or subsystems on an electronic assembly. For example, various controllers, components, and other systems may be employed to execute the operations of the method 200. As described in detail below, the method 200 may measure an impedance characteristic that is associated with signals being transmitted between two subsystems. This impedance measurement may be used to determine that an EM probe is within range of the assembly, and actions may be taken to direct EM emissions from the transmitted signals away from the EM probe. The subsequent FIGS. 3-5 illustrate hardware and/or software structures that may be used during the operations of the method 200.

The method may include transmitting signals between a first subsystem and a second subsystem of an electronic assembly (202). FIG. 3 illustrates a partial schematic 300 of the electronic assembly 100, according to some embodiments. Note that the larger electronic assembly 100 may include many additional subsystems and/or components that are not explicitly shown in FIG. 3 for the sake of clarity. A first subsystem 302 may include an SMPS 310 and any associated components, such as an inductor and decoupling capacitors on the input/output as illustrated in FIG. 3. In other embodiments, the first subsystem 302 may include a cryptographic processor, a memory, a communication chip, other power management circuitry, and/or any other system in the electronic assembly. A second subsystem 304 may include any subsystem that receives power from the SMPS 310. For example, the second subsystem 304 may include a main processor or any other silicon die or subsystem.

The first subsystem 302 and the second subsystem 304 may transmit signals between each other. In this specific example, the first subsystem 302 may send power signals to the second subsystem 304 In other embodiments, the signals may include clock signals, logic signals, encrypted data, unencrypted data, and/or any other type of signal transmission. As described above, the power signals may provide insight into the operations of the electronic assembly, including sensitive operational information that may be of interest to one perpetuating a site-channel attack. The signals transmitted between the first subsystem 302 and the second subsystem 304 may be transmitted through board-level traces, ground planes, power planes, hidden traces, and/or other conductive surfaces that may generate EM emissions that may be detectable by a nearby EM probe.

Turning back to FIG. 2, the method 200 may also include measuring an impedance characteristic associated with the signals as the signals are transmitted between the first subsystem and the second subsystem (204). As illustrated in FIG. 3, the first subsystem 302 may include an inductive loop 308 that is inherent in the circuitry of the SMPS 310. For example, an inductive loop 308 may be formed between the ground connections through the decoupling capacitors at the input and output of the SMPS 310. This inductive loop will be associated with an impedance that may depend at least in part on the component values of the capacitors, the inductor, and other internal circuitry of the SMPS 310.

An impedance measurement may be made at various points in the transmission pathway between the first subsystem 302 and the second subsystem 304. This impedance measurement may be influenced by the impedance of the inductive loop 308 or other impedance elements in the electronic assembly. To provide this impedance measurement, the electronic assembly may include a sensor 312 configured to measure an impedance characteristic associated with the signals as the signals are transmitted between the first subsystem 302 and the second subsystem 304. For example, the sensor 312 may be implemented using an S11 coupler. An S11 coupler is a device used in RF systems to measure a reflection coefficient in a transmission pathway. In this example, the sensor 312 may quantify an amount of the signal transmitted to the second subsystem 304 that is reflected back towards the first subsystem 302. Therefore, the measurement made by the sensor 312 may be referred to as an “impedance characteristic” of the system. This may include a direct impedance measurement or an RF measurement that depends on the impedance, such as the measurements made by the S11 coupler. As described below, the measurement made by the sensor 312 may be used to characterize the impedance and minimize reflections during normal operation to adjust an adjustable impedance of a tuning circuit 306. The measurement made by the sensor 312 may also be used to detect the presence of an EM probe.

To receive and process the measurement of the impedance characteristic from the sensor 312, the system may include an analog-to-digital converter (ADC) 316 configured to receive an analog output of the sensor 312 and to provide a digital input to a controller 318. Some embodiments may also include an attenuator circuit 314 that scales the voltage/current of the measurement from the sensor 312 before being processed by the ADC 316. The sensor 312 may provide continuous samples or characteristic impedance measurements as signals are transmitted between the first subsystem 302 and the second subsystem 304. The ADC 316 may convert these analog signals into digital inputs for the controller 318 at a sample rate high enough to provide real-time mitigation against a side-channel attack. For example, the ADC 316 may convert inputs every 100 ms, every 250 ms, every 500 ms, every 750 ms, every 1 s, and so forth.

The electronic assembly may include a controller 318. The controller 318 may be implemented using a processor, a microprocessor, an FPGA, a system-on-a-chip (SOC), and/or any other programmable logic device. The controller 318 may also be implemented using discrete digital components (e.g., logic gates) as a state machine. The controller 318 may be distributed among a number of different devices. For example, FIG. 3 illustrates a second controller 322 configured to receive component values from the controller 318 and adjust the impedance of the tuning circuit 306 as described in detail below. However, the controller 318 and the second controller 321 may be collectively referred to as the “controller” for the system even though the controller functionality may be distributed between two different chips. For example, the “controller” may include a plurality of controllers, processors, systems on a chip, digital circuits, digital systems, or other components that may control certain activities on the electronic assembly or perform the functions described in the method of FIG. 2. Other control elements may also be included as part of the controller that are not explicitly illustrated in FIG. 3. In some embodiments, the controller 318 may include one or more processors. The controller 318 may also include one or more non-transitory computer-readable media (e.g., instruction memory) configured to store instructions. The instructions, when executed by the one or more processors, may cause the one or more processors to perform the operations described herein, such as at least some of the operations of the method 200.

The controller 318 may store a data structure 320 that stores impedance values, component values, and other EM characteristics of the system at different operating frequencies. The data structure 320 may be used in conjunction with the measured impedance characteristic from the sensor 312 to identify and/or mitigate a side-channel attack.

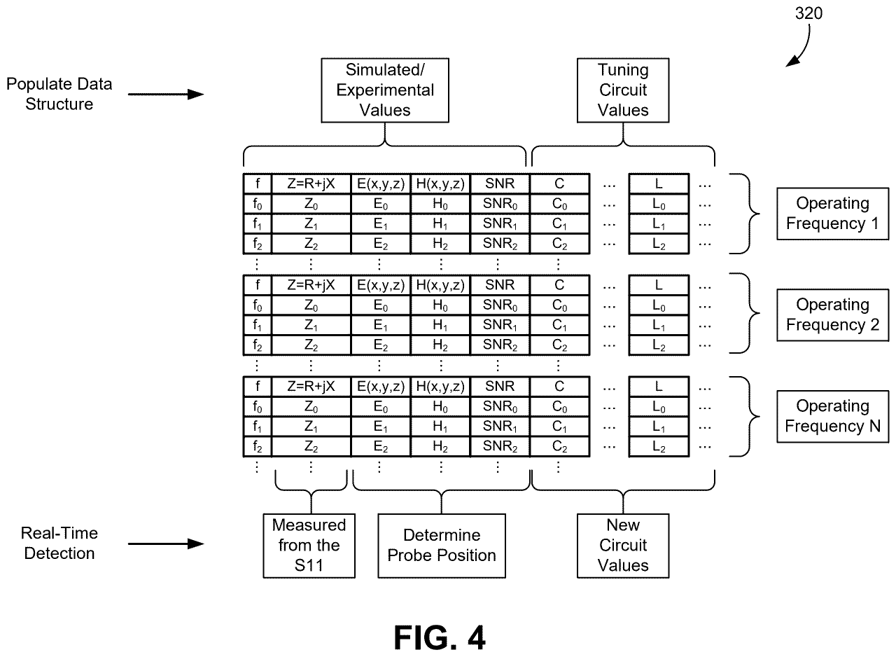

FIG. 4 illustrates an example of the data structure 320 storing various EM characteristics of the system, according to some embodiments. For implementations where the communication between the first subsystem 302 and the second subsystem 304 may use different frequencies, the data structure 320 may store EM characteristics for each of the possible operating frequencies. In the example of FIG. 4, the system may use at least three different operating frequencies for the SMPS 310, although more operating frequencies are also contemplated. In other examples, data may be stored for different clocking frequencies, different communication rates, different transmission rates, different oscillation frequencies, and/or any other operating frequency associated with communication between the two subsystems.

In addition to storing EM characteristics and component values for different operating frequencies, the data structure 320 may also store EM characteristics and component values for any relevant harmonics of each of the operating frequencies. In the example of FIG. 4, the data structure 320 may store values for an operating frequency f₀, while also storing values for fundamental frequencies f₁, f₂, f₃, and so forth. Harmonics may provide a richer dataset to analyze and counteract information leakage across multiple frequencies. They can also offer insights into higher-order leakage patterns. As described below, adjustments to capacitance and inductance values may be tailored, not only for the fundamental frequency, but also for harmonics to ensure comprehensive obfuscation. The real-time tuning circuit 306 may then ensure that the impedance adjustments dynamically align across these frequencies to maintain robust defense against EM probes to obscure the entire spectrum of emissions. This may provide a much more complex and noisy signal space in which an attacker will be forced to operate, which will reduce the ability to extract meaningful information.

For each operating frequency and/or fundamental frequency, the data structure 320 may store a number of different EM characteristics. For example, a range of different impedances Z may be stored in the data structure. This may include a range of impedance values that may be associated with the measured impedance characteristic from the sensor 312. In some embodiments, impedance values may be provided during a test scenario in order to measure or simulate the other EM characteristics in the data structure 320. For example, the method 200 may include simulating the first subsystem at each of the different operating frequencies in the data structure 320 with a plurality of different impedance measurements. The simulation may then provide electric field components and magnetic field components generated each of the different impedance values that may be present at the sensor 312.

For example, for each impedance Z, experimental and/or simulated values may be recorded for EM characteristics of the EM emissions from the signal transmission that correspond to that measured impedance. These EM characteristics may include the signal-to-noise ratio (SNR) of the transmitted signal, an electric field component E(x, y, z), and a magnetic field component H(x, y, z). The electric field component and magnetic field component may be directional with an associated magnitude and orientation.

For example, each impedance value Z may be tested using dynamic load pulling, which is a technique used to test and optimize the performance of the device under varying load impedance conditions. After configuring the system with the dynamic load impedance (which may be provided by adjusting the component values of the tuning circuit 306), the SNR, E(x, y, z), and H(x, y, z) values may be measured//recorded and stored in the data structure 320. This may result in a data structure 320 that is populated with corresponding electric and magnetic field components for any relevant impedance that may be measured by the sensor 312.

In some embodiments, the tuning circuit 306 may be configured to provide the impedance Z for populating the data structure 320. For example, the various capacitance and inductance values may be adjusted in the tuning circuit 306 to provide an adjustable impedance for the test or simulation. These capacitance and inductance values may be stored as the tuning circuit values in FIG. 4. Thus, for any impedance, the data structure 320 may store a full set of EM characteristics along with the corresponding C and L values for the components of the adjustable impedance of the tuning circuit 306.

Note that the tuning circuit 306 in FIG. 3 illustrates series and parallel combinations of adjustable capacitors and adjustable inductors. However, this configuration is provided only by way of example and is not meant to be limiting. Other embodiments may use different arrangements of adjustable capacitors and/or inductors in any configuration. For example, during normal operation, the tuning circuit 306 may be operated as a matching network by the controller 322. In order to minimize loss in the circuit during normal operation, the tuning circuit 306 may be programmed with a matching impedance such that the tuning circuit 306 approximates a direct current (DC) short-circuit and a radio frequency (RF) open circuit when the EM probe is not within range of the electronic assembly. Therefore, although the data structure 320 shows only single capacitance and inductance values at each frequency for the tuning circuit 306, it should be understood that multiple capacitance values and multiple inductance values may be stored corresponding to the physical arrangement of adjustable capacitors and adjustable inductors in the tuning circuit 306.

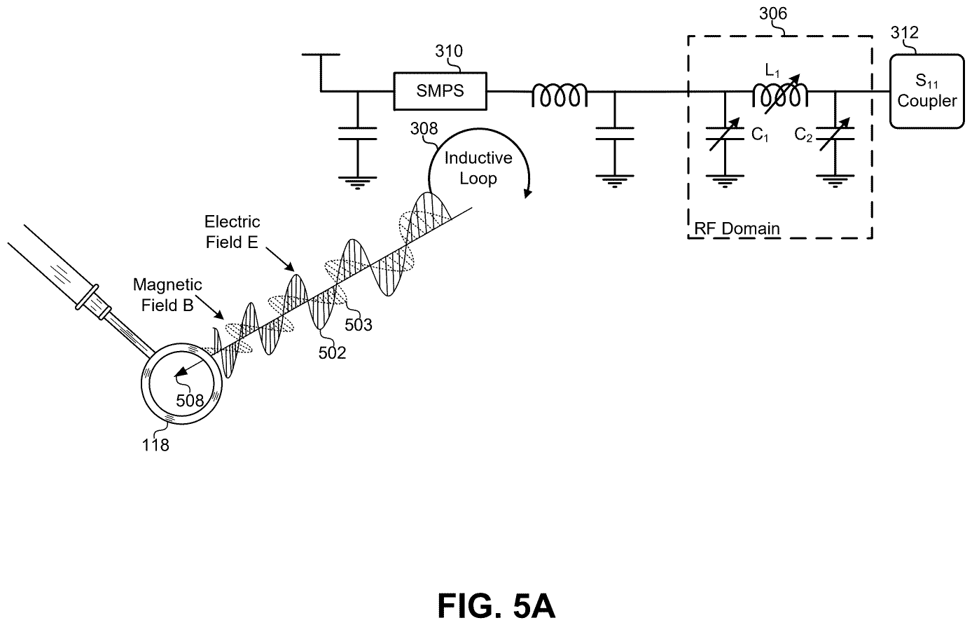

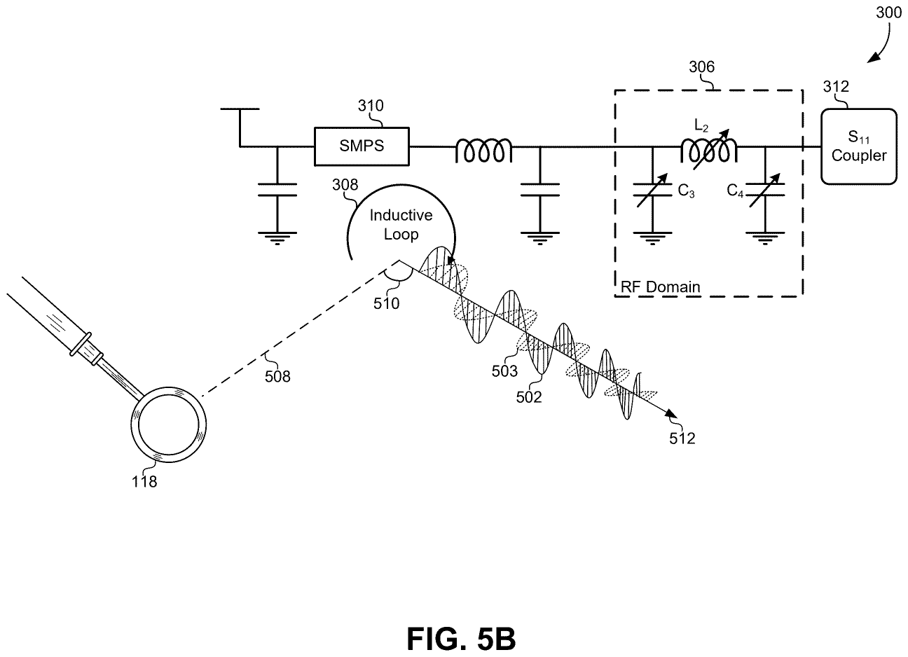

Turning back to FIG. 2, the method 200 may also include determining, based on the impedance characteristic, that an EM probe is within range of the electronic assembly (206). FIG. 5A illustrates an EM probe is within range of the electronic assembly, according to some embodiments. As described above, the sensor 312 may continuously sample the impedance characteristic as the signals are propagated between the first subsystem and the second subsystem. In the absence of an EM probe 118, the sensor 312 may report an expected impedance characteristic back to the controller. When an EM probe is not detected, the tuning circuit 306 may operate as a matching circuit where inductance and/or capacitance values for each of the tuning components are optimized to minimize loss through the tuning circuit 306 (e.g a DC short-circuit and an RF open circuit). This allows the tuning circuit 306 to operate transparently without negatively affecting the operation of the electronic assembly in the absence of an EM probe 118.

However, when the EM probe 118 draws near to the electronic assembly, the measured impedance characteristic from the sensor 312 will change. For example, the EM probe 118 may be exhibit an inductance value that will be coupled to the inductive loop 308 of the electronic assembly. This will effect a change in the inductance measured by the sensor 312. Detecting this change in the impedance characteristic represents one method of determining that the EM probe 118 is close enough to the electronic assembly to be a threat.

In order to mitigate the threat of the EM probe 118, the method 200 may also include directing the EM emissions from the signals away from the location of the EM probe 118 (208). In some embodiments, this process may optionally include determining component values corresponding to an impedance directed away from the probe (210). For example, the system may access the data structure storing impedance values for an operating frequency in the electronic assembly, such as an operating frequency of the first subsystem. As described above, the data structure may include an electric field component 502 and a magnetic field component 503 for each measured impedance value. The electric field component, and the magnetic field component, the SNR, etc., stored in the data structure may represent the electromagnetic characteristics of the electronic assembly in the altered state caused by the presence of the EM probe 118.

From the electric field and magnetic field components stored in the data structure at the new measured impedance, the controller may then calculate an approximate distance and/or orientation of the EM probe 118. For example, a calculation of the distance of the EM probe 118 may be determined using electric field component and magnetic field component. Since the electric and magnetic field component intensities decay with distance according to known models (e.g., 1/r² or 1/r³ depending on the source type). The controller may compare the measured intensities of these electric and magnetic field components against the expected values from the table to estimate the distance of the EM probe 118. The expected values of the electric and magnetic field components may be retrieved from the data structure using the current component values for the tuning circuit 306. Similarly, the orientation of the EM probe 118 relative to the electronic assembly may be derived from the electric and magnetic field components. For example, the orientation of the EM probe may be estimated by calculating changes in the angle associated with the electric and magnetic field components (e.g., the angle based on E, H, and the measured impedance Z (=R+jX)). Specific R and X patterns indicate how the EM probe 118 interacts with the emitted EM field from the electronic assembly. After accessing these measured and expected values in the data structure, the orientation and/or distance to the EM probe 118 may thus be estimated using standard electromagnetic equations.

Based on the orientation of the EM probe 118, the system may stop using the existing inductance and/or capacitance values in the tuning circuit (e.g., the values previously performing a matching function). Instead, new inductance and/or capacitance values may be selected from the data structure corresponding to electric and magnetic field components and an impedance value that cause the direction of the EM emissions from the electronic assembly to be directed away from the EM probe 118. As described above, dynamic load-pull tuning can ensure that these adjustments occur in real time. When the orientation of the EM probe is determined, the system can use new capacitance and inductance (L and C) values to create a new impedance Z in the tuning circuit such that the resulting E and H fields of the emissions from the electronic assembly are directed away from the EM probe. For example, if the measured E, H, and Z values indicate that the EM probe is at an angle α relative to the electronic assembly, the controller may identify E and H values from the data structure that correspond to a radiation pattern/direction for the EM emissions with an angle that is directed away from the EM probe.

FIG. 5B illustrates the EM emissions being directed away from the EM probe, according to some embodiments. The original direction 508 of the EM probe may be determined as described above. New E and H values may be identified from the data structure that result in a new direction 512 for the EM emissions from the electronic assembly. The new direction 512 may have a minimum angle 510 away from the original direction 508. For example, some embodiments may use a minimum angle 510 of greater than or about 45°, greater than or about 90°, greater than or about 135°, or greater than or about 180°. The controller may search the data structure for E and H values that correspond to any new direction where the resulting angle is greater than or equal to the minimum angle 510. In determining the electric field component and magnetic field component from the data structure, the controller may also determine whether the new orientation will have an SNR that is less than the SNR at the current position or less than a threshold SNR. This may ensure that any EM emissions that are leaked to the EM probe are reduced below a usable level. Additionally, the SNR values across the harmonics at the specified E and H values may also be reduced or be adjusted below a threshold value. This ensures that any impedance adjustments dynamically align across all emitted frequencies to maintain a robust defense against the EM probe and to ensure that the entire spectrum of emissions are obfuscated.

The method 200 may additionally include providing the component values to the tuning circuit to cause the EM emissions to be directed away from the EM probe (212). When the appropriate E and H values are selected that move the orientation of the EM emissions to the new direction 512 and/or sufficiently reduce the SNR of the EM emissions, the corresponding capacitance/inductance values from that row in the data structure 320 may be accessed. These component values for the tuning circuit may correspond to a second impedance with a new (or “second”) electric field component and a new (or “second”) magnetic field component that are directed away from the position of the EM probe. The controller may then send the capacitance/inductance values to the tuning circuit 306 to adjust the adjustable impedances. For example, the controller may adjust the capacitance of a variable capacitor and/or adjust the inductance of a variable inductor using standard techniques in matching circuits. This change in impedance of the tuning circuit 306 may then cause the actual EM emissions between the two subsystems to be diverted away from the EM probe 118 as depicted in FIG. 5B.

Since the sensor samples the impedance characteristic continuously, and the new component values for the tuning circuit 306 can be adjusted in real time, the system may dynamically adjust the impedance of the tuning circuit based on real-time measurements and pre-characterized values in the data structure to create a “moving target” for potential attackers. This effectively neutralizes the EM probe as a side-channel attack method. Moreover, this represents a proactive defense against side-channel attacks that maintains the functional integrity of the electronic assembly by continuously adjusting the tuning circuit in response to any movement by the EM probe.

For example, after adjusting the tuning circuit to steer the EM emissions into the new direction 512, an attacker using the EM probe may again adjust the position of the EM probe to attempt to find a data leak. In real time, the system can continuously detect the position of the EM probe as it moves around the electronic assembly by continuing to measure the impedance characteristic associated with the transmitted signals after directing the EM emissions away from the EM probe. As the EM probe moves, the impedance characteristic measured by the sensor may continue to change. Using the same methods described above, the controller may determine that the EM probe has moved to a new location based on a detected change in measured impedance characteristic. The controller may then select new L and C values from the data structure for the tuning circuit to redirect the EM emissions from the signals away from the new location of the EM probe.

Some embodiments may rely exclusively on steering the direction of the EM emissions to defeat side channel attacks. Alternatively, some embodiments may combine this steering technique with any of the other side-channel mitigation techniques described herein. For example, some embodiments may both steer the EM emissions away from the EM probe while also injecting noise into the signals being transmitted between the first and second subsystems. When the EM probe is detected using the change in the impedance measurement, the system may begin injecting noise into the transmitted signals. Likewise, the controller may cause the injected noise to be removed once the EM probe is no longer detected. This allows traditional mitigation techniques to be employed only while the EM probe is a threat, which reduces the overhead and interference with the normal functioning of the electronic assembly.

It should be appreciated that the specific steps illustrated in FIG. 2 provide particular methods of protecting communications between two subsystems according to various embodiments. Other sequences of steps may also be performed according to alternative embodiments. For example, alternative embodiments may perform the steps outlined above in a different order. Moreover, the individual steps illustrated in FIG. 2 may include multiple sub-steps that may be performed in various sequences as appropriate to the individual step. Furthermore, additional steps may be added or removed depending on the particular applications. Many variations, modifications, and alternatives also fall within the scope of this disclosure.

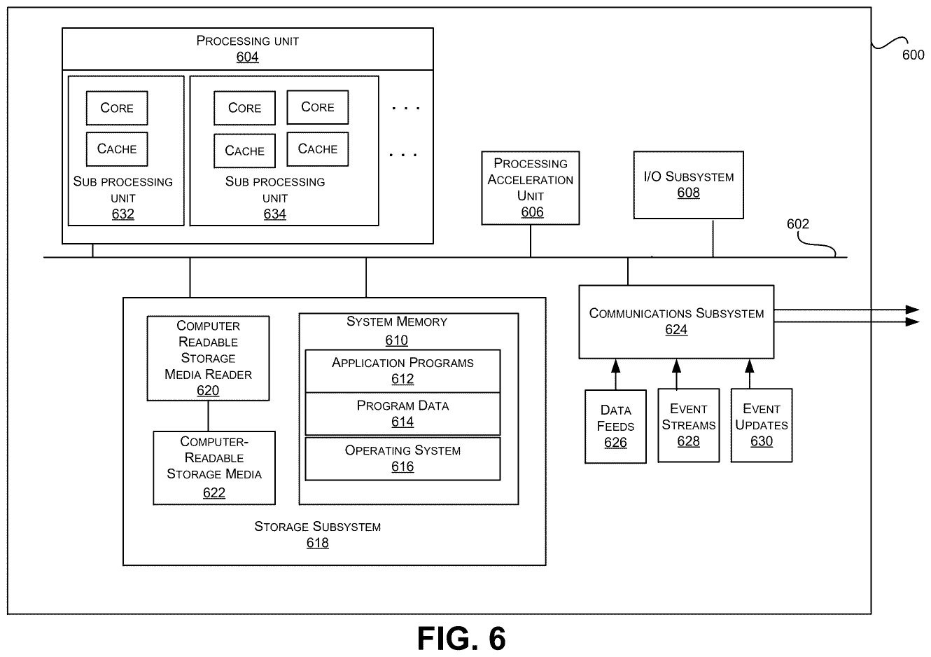

FIG. 6 illustrates an exemplary controller 600, in which various embodiments may be implemented. The controller 600 may be used to implement any of the computer systems, processors, controllers, systems-on-a-chip, or other processing means described herein. As shown in the figure, controller 600 includes a processing unit 604 that communicates with a number of peripheral subsystems via a bus subsystem 602. These peripheral subsystems may include a processing acceleration unit 606, an I/O subsystem 608, a storage subsystem 618 and a communications subsystem 624. Storage subsystem 618 includes tangible computer-readable storage media 622 and a system memory 610.

Bus subsystem 602 provides a mechanism for letting the various components and subsystems of controller 600 communicate with each other as intended. Although bus subsystem 602 is shown schematically as a single bus, alternative embodiments of the bus subsystem may utilize multiple buses. Bus subsystem 602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, EtherCAT, and Peripheral Component Interconnect (PCI) bus, which can be implemented as a Mezzanine bus manufactured to the IEEE P1386.1 standard.

Processing unit 604, which can be implemented as one or more integrated circuits (e.g., a conventional microprocessor or microcontroller), controls the operation of controller 600. One or more processors may be included in processing unit 604. These processors may include single core or multicore processors. In certain embodiments, processing unit 604 may be implemented as one or more independent processing units 632 and/or 634 with single or multicore processors included in each processing unit. In other embodiments, processing unit 604 may also be implemented as a quad-core processing unit formed by integrating two dual-core processors into a single chip.

In various embodiments, processing unit 604 can execute a variety of programs in response to program code and can maintain multiple concurrently executing programs or processes. At any given time, some or all of the program code to be executed can be resident in processing unit 604 and/or in storage subsystem 618. Through suitable programming, processor(s) 604 can provide various functionalities described above. Controller 600 may additionally include a processing acceleration unit 606, which can include a digital signal processor (DSP), a special-purpose processor, and/or the like.

I/O subsystem 608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices.

User interface output devices may include a display subsystem, indicator lights, or non-visual displays such as audio output devices, etc. The display subsystem may include a flat-panel device, such as that using a liquid crystal display (LCD) or plasma display, a projection device, a touch screen, and the like. In general, use of the term “output device” is intended to include all possible types of devices and mechanisms for outputting information from controller 600 to a user or other computer. For example, user interface output devices may include, without limitation, a variety of display devices that visually convey text, graphics and audio/video information such as monitors, printers, speakers, headphones, plotters, voice output devices, modems, and/or the like.

Controller 600 may include a storage subsystem 618 that comprises software elements, shown as being currently located within a system memory 610. System memory 610 may store program instructions that are loadable and executable on processing unit 604, as well as data generated during the execution of these programs.

Depending on the configuration and type of controller 600, system memory 610 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 604. In some implementations, system memory 610 may include multiple different types of memory, such as static random access memory (SRAM) or dynamic random access memory (DRAM). In some implementations, a basic input/output system (BIOS), containing the basic routines that help to transfer information between elements within controller 600, such as during start-up, may typically be stored in the ROM. By way of example, and not limitation, system memory 610 also illustrates application programs 612, which may include client applications, Web browsers, mid-tier applications, relational database management systems (RDBMS), etc., program data 614, and an operating system 616.

Storage subsystem 618 may also provide a tangible computer-readable storage medium for storing the basic programming and data constructs that provide the functionality of some embodiments. Software (programs, code modules, instructions) that when executed by a processor provide the functionality described above may be stored in storage subsystem 618. These software modules or instructions may be executed by processing unit 604. Storage subsystem 618 may also provide a repository for storing data used in accordance with some embodiments.

Storage subsystem 618 may also include a computer-readable storage media reader 620 that can further be connected to tangible computer-readable storage media 622. Together, and optionally in combination with system memory 610, tangible computer-readable storage media 622 may comprehensively represent remote, local, fixed, and/or removable storage devices plus storage media for temporarily and/or more permanently containing, storing, transmitting, and retrieving computer-readable information.

Tangible computer-readable storage media 622 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, including optical storage, magnetic storage, magnetic disk storage or other magnetic storage devices, or other tangible computer readable media. This can also include nontangible computer-readable media, such as data signals, data transmissions, or any other medium which can be used to transmit the desired information, and which can be accessed by computing system 600.

By way of example, tangible computer-readable storage media 622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Tangible computer-readable storage media 622 may include, but is not limited to, flash memory cards, universal serial bus (USB) flash drives, secure digital (SD) cards, disks, digital video tape, and the like. Tangible computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for controller 600.

Communications subsystem 624 provides an interface to other computer systems and networks. Communications subsystem 624 serves as an interface for receiving data from and transmitting data to other systems from controller 600. For example, communications subsystem 624 may enable controller 600 to connect to one or more devices via the Internet. In some embodiments communications subsystem 624 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), and/or other components. In some embodiments, communications subsystem 624 can provide wired network connectivity (e.g., Ethernet) in addition to or instead of a wireless interface.

In some embodiments, communications subsystem 624 may also receive input communication in the form of structured and/or unstructured data feeds 626, event streams 628, event updates 630, and the like on behalf of one or more users who may use controller 600.

Additionally, communications subsystem 624 may also be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 624 may also be configured to output the structured and/or unstructured data feeds 626, event streams 628, event updates 630, and the like to one or more databases that may be in communication with one or more streaming data source computers coupled to controller 600.

Due to the ever-changing nature of computers and networks, the description of controller 600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

As used herein, the terms “about” or “approximately” or “substantially” may be interpreted as being within a range that would be expected by one having ordinary skill in the art in light of the specification. By way of example, these terms may imply a 10% variation above or below a stated value (i.e., “approximately 50” would imply a range between 45 and 55).

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. An electronic assembly comprising:
a first subsystem;
a second subsystem, wherein signals are transmitted between the first subsystem and the second subsystem;
a tuning circuit with an adjustable impedance through which the signals are transmitted;
a sensor configured to measure an impedance characteristic associated with the signals as the signals are transmitted between the first subsystem and the second subsystem; and
a controller programmed to:
determine, based on the impedance characteristic, that an electromagnetic (EM) probe is within range of the electronic assembly; and
change the adjustable impedance of the tuning circuit to direct EM emissions from the signals away from the EM probe.

2. The electronic assembly of claim 1, wherein the tuning circuit comprises one or more adjustable capacitors and one or more inductors.

3. The electronic assembly of claim 1, wherein the tuning circuit is configured to operate as a matching circuit to adjust the adjustable impedance such that the tuning circuit approximates a direct current (DC) short-circuit and a radio frequency (RF) open circuit when the EM probe is not within range of the electronic assembly.

4. The electronic assembly of claim 1, wherein the sensor configured to measure the impedance comprises an S11 coupler between the tuning circuit and the second subsystem.

5. The electronic assembly of claim 1, further comprising an analog-to-digital converter (ADC) configured to receive an analog output of the sensor and to provide a digital input to the controller.

6. The electronic assembly of claim 1, wherein the first subsystem comprises a switch-mode power supply (SMPS).

7. The electronic assembly of claim 1, wherein the controller comprises a plurality of controllers, processors, systems-on-a-chip, or digital systems.

8. A method of mitigating a side-channel attack, the method comprising:
transmitting signals between a first subsystem and a second subsystem of an electronic assembly;
measuring an impedance characteristic associated with the signals as the signals are transmitted between the first subsystem and the second subsystem;
determining, based on the impedance characteristic, that an electromagnetic (EM) probe is within range of the electronic assembly; and
directing EM emissions from the signals away from the EM probe.

9. The method of claim 8, further comprising:
populating a data structure with EM characteristics of the electronic assembly at a plurality of different operating frequencies of the first subsystem, wherein the EM characteristics comprise an impedance with electric field components and magnetic field components.

10. The method of claim 9, further comprising:
populating the data structure with the EM characteristics for a plurality of harmonic frequencies at each of the different operating frequencies of the first subsystem.

11. The method of claim 9, wherein populating a data structure with the EM characteristics comprises:
simulating the first subsystem at each of the different operating frequencies with a plurality of different impedance measurements, wherein the simulation provides the electric field components and the magnetic field components at each of the plurality of different impedance measurements.

12. The method of claim 8, wherein directing the EM emissions from the signals away from the EM probe comprises:
determining component values for a tuning circuit with an adjustable impedance through which the signals are transmitted, wherein the component values cause the EM emissions from the signals to have less than a threshold signal-to-noise ratio (SNR) in a direction of the EM probe.

13. The method of claim 8, further comprising injecting noise into the signals being transmitted between the first subsystem and the second subsystem.

14. The method of claim 8, further comprising:
measuring the impedance characteristic associated with the signals after directing the EM emissions from the signals away from the EM probe;
determining, based on the impedance characteristic, that the EM probe has moved to a new location; and
redirecting the EM emissions from the signals away from the EM probe at the new location.

15. One or more non-transitory computer-readable media comprising instructions that, when executed by one or more processors, cause the one or more processors to perform operations comprising:
receiving an impedance characteristic associated with signals that are transmitted between a first subsystem and a second subsystem on an electronic assembly;
determining, based on the impedance characteristic, that an electromagnetic (EM) probe is within range of the electronic assembly; and
determining component values for a tuning circuit with an adjustable impedance through which the signals are transmitted, wherein the component values are configured to cause EM emissions from the signals to be directed away from the EM probe.

16. The one or more non-transitory computer-readable media of claim 15, wherein determining that the EM probe is within the range of the electronic assembly comprises:
detecting a change in the impedance characteristic.

17. The one or more non-transitory computer-readable media of claim 15, further comprising:
accessing a data structure storing impedance values for an operating frequency of the first subsystem, where in the data structure comprises electric field components and magnetic field components for each impedance value.

18. The one or more non-transitory computer-readable media of claim 17, further comprising:
determining an electric field component and a magnetic field component from the data structure based on the impedance characteristic.

19. The one or more non-transitory computer-readable media of claim 18, further comprising:
determining a position of the EM probe relative to the electronic assembly based on the electric field component and the magnetic field component.

20. The one or more non-transitory computer-readable media of claim 19, further comprising:
determining the component values for the tuning circuit corresponding to a second impedance with a second electric field component and a second magnetic field component that are directed away from the position of the EM probe.
